(19) United States
(12) Patent Application Publication
(10) Pub. No.: US 2009/0145352 A1
(43) Pub. Date: Jun. 11, 2009

(54) Hand Portioner

(75) Inventor: Cliff Allen, East Sussex (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Mitchell & Cooper Limited

(21) Appl. No.: 12/188,450

(22) Filed: Aug. 8, 2008

(30) Foreign Application Priority Data
Aug. 16, 2007 (GB) GB 0716013.8

(51) Int. Cl. A21C 9/04; G01F 19/00

(52) U.S. Cl. 118/18; 73/426

(57) ABSTRACT

The present invention provides a hand portioner (10) having a handle (12) and a scoop (14), the hand portioner (10) further being provided with a spreading blade (34) extending from said handle (12). The spreading blade (34) is provided to the rear of the scoop (14), which is to say it does not overlie the bowl of the scoop (14), and hence does not impede the operation of the scoop (14). The spreading blade (34) enables a user of the hand portioner (10) to both measure, dispense and spread a portion of a soft food product with a single hand implement.

The present invention relates to a hand portioner having a handle and a scoop. Hand portioners of this type may be used to measure and dispense a portion of a soft food product such as, for example, mayonnaise from a tub or like container,

Hand portioners may be used in the manner described above to deposit a portion of a soft food product at a desired location such as, for example, a bakery product The portion of soft food product may subsequently need to be spread over the surface of the bakery product. Spreading of the soft food product may be achieved by using the outside of the scoop, however it is very difficult to spread the soft food product evenly using this method.

According to the present invention there is provided a hand portioner having a handle and a scoop, the hand portioner further being provided with a spreading blade extending from said handle.

The blade is provided to the rear of the scoop, which is to say it does not overlie the bowl of the scoop, and hence does not impede the operation of the scoop. The blade enables a user of the hand portioner to both measure, dispense and spread a portion of a soft food product with a single hand implement.

In a preferred embodiment the spreading blade is releasably connected to the handle. The blade may this be removed for cleaning and/or replaced. The blade may be provided with a projection which is receivable in a complimentarily shaped recess of the handle. Preferably the projection and recess are formed such that the blade is prevented from moving relative to the handle, in use.

The scoop of the hand portioner may be joined to the handle by a stem. The blade may, in use, be aligned in a substantially parallel manner to the stem.

The blade may be configured in a manner such that it is able to impart a desired texture or pattern to the portion of soft food product. For example one or both edges of the blade may be serrated, scalloped or otherwise contoured. Alternatively, or in addition to, the aforementioned configuration of the or each blade edge, the flat of the blade may be configured so as to be able impart a desired texture to the dispensed portion of soft food product. For example, the flat of the blade may be provided with one or more raised letters, numbers or images which may be embossed upon the dispensed portion of soft food product.

The blade may comprise a blade portion and a tang. In one embodiment the blade and tang may lie in substantially the same plane. In an alternative embodiment, the tang and blade portion may be substantially perpendicular to one another.

According to a further aspect of the present invention there is provided a spreading blade for a hand portioner, the spreading blade being provided with a projection which is receivable in a complimentarily shaped recess of the handle of a hand portioner.

The projection may be shaped so as to prevent rotation of the spreading blade relative to the recess of the handle of a hand portioner, in use. Alternatively, or in addition to the shape of the projection the spreading blade may be provided with a bearing portion which, in use, abuts the handle of a hand portioner to prevent the spreading blade from rotating relative to the handle.

The spreading blade may configured in a manner such that it is able to impart a desired texture or pattern to a portion of a food product dispensed from a hand portioner to which the spreading blade has been fitted. For example, an edge of the spreading blade is serrated, scalloped or otherwise contoured. Both edges of the spreading blade are serrated, scalloped or otherwise contoured. Additionally or alternatively to the blade edges the flat of the spreading blade is configured so as to be able impart a desired texture to a portion of food product dispensed from a hand portioner to which the spreading blade has been fitted. In such an embodiment the flat of the spreading blade is provided with one or more raised letters, numbers, figures, logos, images or the like.

An embodiment of the present invention will now be described with reference to the accompanying drawings in which:

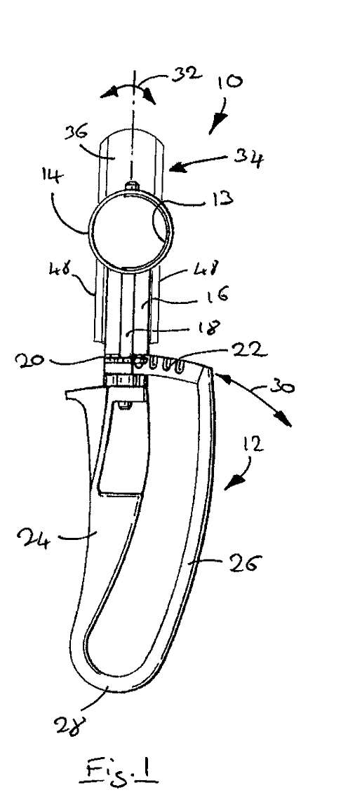

FIG. 1 shows a top plan view of a band portioner having a spreader blade in accordance with the present invention;

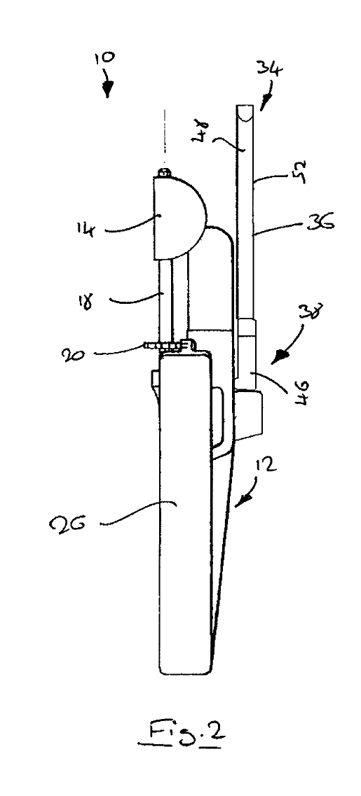

FIG. 2 shows a side view of the hand portioner of FIG. 1;

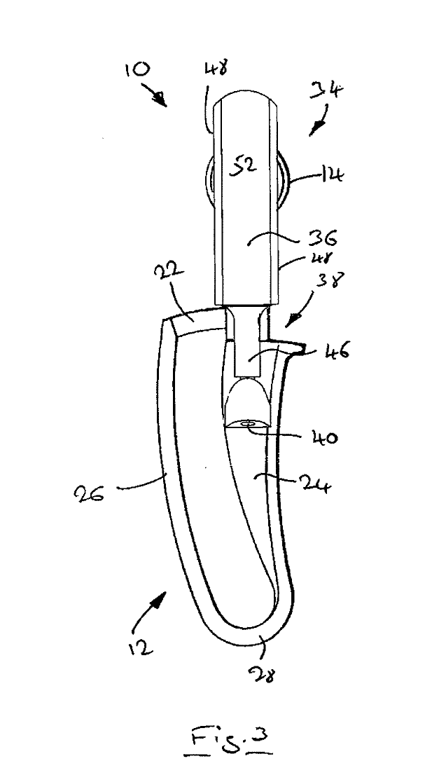

FIG. 3 shows a bottom plan view of the hand portioner of FIG. 1:

FIGS. 4 and 5 show end views of the spreader blade;

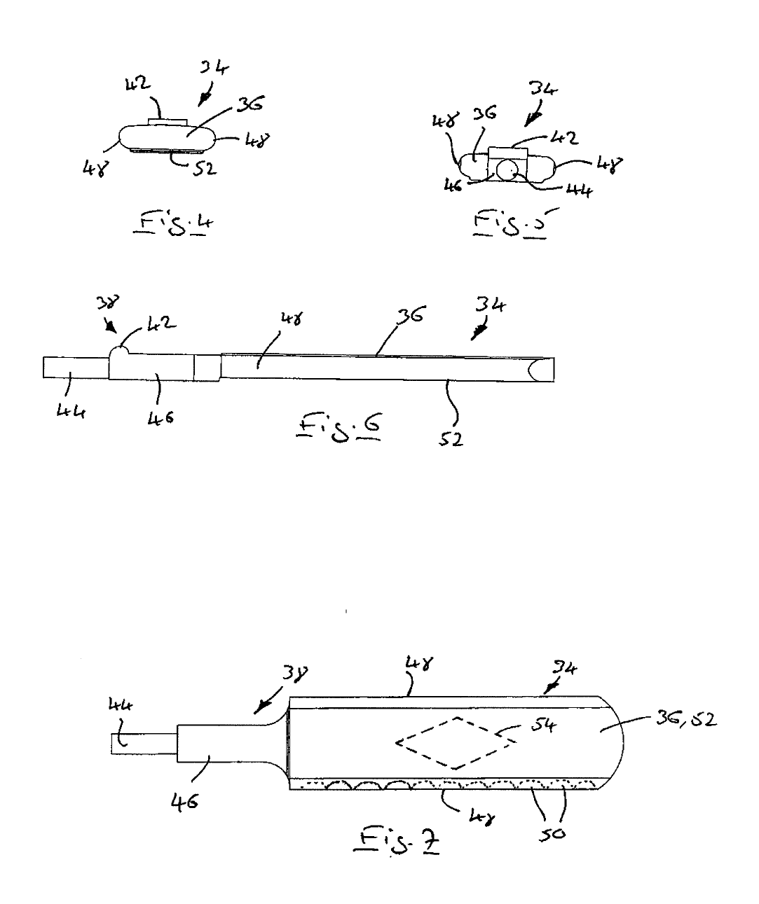

FIG. 6 shows a side view of the spreader blade; and

FIG. 7 shows a plan view of the spreader blade.

Referring to FIGS. 1 to 3 there is shown a hand portioner generally designated 10. The portioner 10 includes a handle 12 and a scoop 14. The scoop 14 is joined to the handle 12 by a stem 16. In the embodiment shown the portioner 10 is provided with a release blade 13 which is movably mounted within the scoop 14. The release blade is curved so as to conform to the shape of the interior of the scoop 14. The release blade is connected to a drive shaft 18 which lies substantially parallel to the stem 16 and is mounted between the scoop 14 and handle 12. The shaft 18 is rotatable as indicated by arrow 32. The shaft 18 is provided with a cog 20 which engages a toothed rack 22 of the handle 12.

The handle 12 comprises a grip portion 24 and a trigger portion 26. The grip and trigger portions 24,26 are formed integrally with one another and are joined by a curved intermediate portion 28. The handle 12 is formed from a plastics material and the trigger portion 26 may be moved towards and away from the grip portion 24 as indicated by arrow 30, The natural resilience of the plastics material urges the trigger portion 26 away from the grip portion 24 to the rest position shown in the figures. In use, a user holds the handle 12 such that the grip portion 24 rests in their palm and the trigger portion 26 against their fingers. By movement of the user's fingers towards their palm, the trigger portion 26 may be moved towards the grip portion 24, This causes the rack 22 to move the cog 20 and rotate both the shaft 18 and release blade.

To assist with the spreading of a portion of soft food product dispensed from the scoop 14, the portioner 10 is provided with a spreader blade generally designated 34. The blade 34 is provided with a blade portion 36 and a tang 38. A portion of the tang 38 is receivable in a correspondingly shaped aperture 40 provided in the grip portion 24 of the handle 12. The tang 38 and aperture 40 may be complimentarily shaped such that the blade 34 is not able to rotate about its longitudinal axis, in use. For example, the tang 38 and aperture 40 may be hexagonal in cross section. Alternatively, the blade 34 may be provided with a bearing portion 42 on the side of the blade 34 facing the handle 12 which, in use, rests against the handle 12 to prevent rotation of the blade 34. In the embodiment shown the bearing portion 42 comprises a raised projection which extends across the blade tang 38 in a direction substantially perpendicular to the longitudinal axis of the blade 34.

The tang 38 and aperture 40 are also configured such that the blade 34 securely attaches to the handle 12 but may be removed for cleaning or replaced. For example, there may exist a slight interference fit between the tang 38 and aperture 40. In the embodiment shown the blade 36 is aligned with the stem 16.

In the embodiment shown the tang 38 and blade portion 36 line in substantially the same plane as on another, and the aperture 40 of the grip portion 24 lies substantially parallel to the drive shaft 18 and stem 16. In an alternative embodiment, the tang 38 may lie substantially perpendicular to the plane of the blade portion 36. In such an embodiment the aperture 40 extends into the grip portion 24 in a direction substantially perpendicular to the axes of the drive shaft 18 and stem 16.

It will be appreciated that the aperture 40 may be provided at other locations on the handle such that blade 36 is positioned differently. The position of the blade 36 must however not impede the filling and subsequent dispensing of soft food product from the scoop. The blade 36 is manufactured from a plastics material.

In use, a user uses the portioner 10 to measure and then dispense a portion of soft food product in the conventional manner. The user may then spread the portion of soft food product with the blade 36.

While the above described embodiment relates to a portioner 10 having a release blade, it will be understood that the spreader blade of the present invention may be incorporated into other types of portioner such as an ice-cream scoop.

Referring now to FIGS. 4 to 7 there is shown the blade 34. Previously described features of the blade 34 are identified with like reference numerals. The tang 38 includes a first portion 44 which is receivable in the handle aperture 40, and an intermediate portion 46 extending between the first portion 44 and the blade 34. In the embodiment shown, the first portion 44 is substantially circular in cross-section. It will be appreciated that the first portion may be configured with other cross-sectional shapes which are mirrored by the cross-sectional shape of the handle aperture 40. The bearing portion 42 is provided on the intermediate portion 46 of the tang 38. In the embodiment shown, the bearing portion 42 is positioned at the end of the intermediate portion which is distal to the blade portion 36.

One or both edges 48 of the blade portion 36 may be shaped so as to impart a desired appearance or texture to a soft food product spread by the blade 34. For example, one or both edges 48 may be provided with serrations 50. The flat 52 of the blade portion 36 which, in use faces away from the handle 12 may further be configured so as to be able impart a desired texture to the dispensed portion of soft food product. For example, the flat 52 of the blade portion 36 may be provided with one or more raised letters, numbers or images which may be pressed into the dispensed portion of soft food product to emboss the dispensed portion of soft food product. FIG. 7 illustrates a diamond shape indicated by broken lines 54.

1. A hand portioner for dispensing a measured quantity of a food product, the hand portioner having a handle and a scoop, the band portioner further including a spreading blade extending from said handle.

2. A hand portioner as claimed in claim 1 wherein the blade is provided to the rear of the scoop

3. A hand portioner as claimed in claim 1 wherein the spreading blade is releasably connected to the handle.

4. A hand portioner as claimed in claim 3 wherein the spreading blade is provided with a projection which is receivable in a complimentarily shaped recess of the handle.

5. A hand portioner as claimed in claim 4 wherein the projection and recess are configured such that the spreading blade is prevented from rotating relative to the handle, in use.

6. A hand portioner as claimed in claim 4 wherein the spreading blade is provided with a bearing portion which abuts the handle to prevent the spreading blade from rotating relative to the handle.

7. A hand portioner as claimed in claim 1 wherein the scoop of the hand portioner is joined to the handle by a stem and the spreading blade is aligned in a substantially parallel manner to the stem.

8. A hand portioner as claimed in claim 1 wherein the spreading blade is configured in a manner such that it is able to impart a desired texture or pattern to a portion of a food product dispensed from the scoop.

9. A hand portioner as claimed in claim 8 wherein an edge of the spreading blade is serrated, scalloped or otherwise contoured.

10. A hand portioner as claimed in claim 9 wherein both edges of the spreading blade are serrated, scalloped or otherwise contoured.

11. A hand portioner as claimed in claim 8 wherein the flat of the spreading blade is configured so as to be able impart a desired texture to a portion of food product dispensed from the scoop.

12. A hand portioner as claimed in claim 11 wherein the flat of the spreading blade is provided with one or more raised letters, numbers, figures, logos, images or the like.

13. A spreading blade for a hand portioner, the spreading blade being provided with a projection which is receivable in a complimentarily shaped recess of the handle of a hand portioner.

14. A spreading blade as claimed in claim 13 wherein the projection is shaped so as to prevent rotation of the spreading blade relative to the recess of the handle of a hand portioner, in use.

15. A spreading blade as claimed in claim 13 wherein the spreading blade is provided with a bearing portion which, in use, abuts the handle of a hand portioner to prevent the spreading blade from rotating relative to the handle.

16. A spreading blade as claimed in claim 13 wherein the spreading blade is configured in a manner such that it is able to impart a desired texture or pattern to a portion of a food product dispensed from a hand portioner to which the spreading blade has been fitted.

17. A spreading blade as claimed in claim 16 wherein an edge of the spreading blade is serrated, scalloped or otherwise contoured.

18. A spreading blade as claimed in claim 17 wherein both edges of the spreading blade are serrated, scalloped or otherwise contoured.

19. A spreading blade as claimed in claim 16 wherein the flat of the spreading blade is configured so as to be able impart a desired texture to a portion of food product dispensed from a hand portioner to which the spreading blade has been fitted.

20. A spreading blade as claimed in claim 19 wherein the flat of the spreading blade is provided with one or more raised letters, numbers, figures, logos, images or the like.
